(19) United States
(12) Patent Application Publication
(10) Pub. No.: US 2008/0252947 A1
(43) Pub. Date: Oct. 16, 2008

(54) IMAGE PROCESSING APPARATUS AND NETWORK MULTIFUNCTION PERIPHERAL

(75) Inventor: Katsushi MINAMINO, Kyoto-shi (JP)

Correspondence Address: MURATA MACHINERY, LTD.;(MURATEC) c/o KEATING & BENNETT LLP, 1800 Alexander Bell Drive, SUITE 200, MCLEAN, VA, 20191, US

(73) Assignee: MURATA MACHINERY, LTD., Kyoto-shi (JP)

(21) Appl. No.: 12/062,660

(22) Filed: Apr. 4, 2008

(30) Foreign Application Priority Data
Apr. 11, 2007 (JP) 2007-104337

(51) Int. Cl. H04N 1/04

(52) U.S. Cl. 358/494

(57) ABSTRACT

An image processing apparatus includes a CPU arranged to select one of a plurality of pixel rates including a normal pixel rate and high pixel rates which are higher than the normal pixel rate when processing at a low resolution. The image processing apparatus also includes a timing generator arranged to control a CCD line sensor so that the pixel data is outputted at the selected pixel rate, a switch arranged to select the pixel data of pixels at different positions in a line, from line to line, from among the pixel data acquired by scanning the plurality of consecutive lines according to a control signal from the timing generator, and an ASIC arranged to import the selected pixel data and apply different filters to the imported pixel data depending on the line where the target data to be acquired is positioned.

### CROSS-REFERENCE TO RELATED APPLICATIONS

This application claims priority under 35 U.S.C. 119 to Japanese Patent Application No. 2007-104337, filed on Apr. 11, 2007, which application is hereby incorporated by reference in its entirety.

### BACKGROUND OF THE INVENTION

1. Field of the Invention

The present invention relates to an image processing apparatus which is able to process a document image at a plurality of different resolutions and a network multifunction peripheral including such an image processing apparatus.

2. Description of Related Art

In recent years, a network multifunction peripheral having a copying function, a facsimile communication function, and a network scanner function combined together is widely used for saving space. In the network multifunction peripheral, the document image is processed at standard resolutions depending on the function, such as 300 dpi for a facsimile communication and 600 dpi for a copying function or a network scanner function, or at a resolution specified by the user.

In the related art, an image processing apparatus for processing a document image at such a plurality of resolutions is known (for example, see JP-A-2000-59583). This image processing apparatus stores shading information, which is alternately acquired from an image sensor for odd-numbered pixels and even-numbered pixels, in an image processor (referred to as “image processing mask” in JP-A-2000-59583). Then, in this image processor, the odd-numbered pixels are subjected to image processing referring only to the peripheral odd-numbered pixels, and the even-numbered pixels are subjected to image processing referring only to the peripheral even-numbered pixels, and then the shading information of the rows acquired as a result of the image processing are outputted from the image processor.

In this image processing apparatus, by discarding one of the result of image processing on the odd-numbered pixels and the result of image processing on the even-numbered pixels and using the other one of the results, image processing at a low resolution (half the original resolution) is achieved.

When the image sensor outputs the shading information for the odd-numbered pixels and the shading information for the even-numbered pixels using different shift registers, respectively, there may occur non-uniformity in the shading information therebetween depending on the difference in characteristics of the shift registers. In such a case as well, by processing only one of the odd-numbered pixels and the even-numbered pixels, the non-uniformity is prevented from becoming obvious, so that quality deterioration as a result of the image processing is prevented.

However, with the image processing apparatus in the related art, the shading information acquired for all the pixels from the image sensor is imported into the image processor even when the image is processed at a low resolution, and hence the following problems may occur.

FIG. 11 is a drawing conceptually illustrating a configuration of a general image processing apparatus 90 in the related art. In the description, it is assumed that an image processor 93 is generally a space filter for image data and is defined, for example, by an Application Specific Integrated Circuit (ASIC).

In the image processing apparatus 90, a CCD line sensor 91 transfers the shading information for the odd-numbered pixels and the even-numbered pixels using independent shift registers respectively, not illustrated, and outputs the same to a multiplexer 92. The CCD line sensor 91 outputs the shading information individually on the odd-numbered pixels and the even-numbered pixels at a rate of R pixels/second.

The multiplexer 92 multiplexes the shading information for the odd-numbered pixels and the even-numbered pixels to output the shading information for all the pixels to the image processor 93 at a rate of 2R pixels/second. The image processor 93 imports this shading information for all the pixels and performs the image processing at a normal resolution or a low resolution.

When processing the document image at a low resolution, since the data quantity that the image processor 93 should process is substantially half the data quantity to be processed at the normal resolution, it is desired that the image processor 93 imports the data at a speed, for example, two times the speed of processing at the normal resolution in order to utilize the maximum image processing capability provided for processing at the normal resolution.

However, there may be a case in which high-speed data importing cannot be achieved depending on the process of manufacturing the ASIC for the image processor 93. Or, in contrast, when the manufacturing process which achieves high-speed data importing is excessive for the image processing capability, there is a useless increase in the cost of the image processor 93.

### SUMMARY OF THE INVENTION

In order to overcome the problems described above, preferred embodiments of the present invention provide an image processing apparatus which helps the ASIC have the maximum capability for processing at a normal resolution and at a low resolution without increasing the speed of data importing by the ASIC. Additionally, the preferred embodiments of the present invention enable the user to trade-off between the processing speed and the power consumption when processing the document image at a low resolution in the image processing apparatus.

An image processing apparatus according to a preferred embodiment of the present invention is preferably an image processing apparatus for processing pixel data acquired by scanning a document with a line sensor at a normal resolution and at a low resolution which is lower than the normal resolution, and preferably includes a controller arranged to select one of a plurality of pixel rates including high pixel rates which are higher than a normal pixel rate used in the processing at the normal resolution and control the line sensor so that the pixel data is outputted at the selected pixel rate when processing at the low resolution; a selector arranged to select the pixel data of pixels at different positions in the line on a line-to-line basis from pixel data acquired by scanning a plurality of consecutive lines; and an image processor arranged to generate target data by importing the selected pixel data and applying different space filters to the imported pixel data depending on the line where the target data to be acquired is positioned.

The controller may select the pixel rate according to a specifying operation executed by a user.

The selector may select only one pixel data of pixels at the same position in the line from among pixel data acquired by scanning consecutive N lines (N is an integer larger than one).

The image processor preferably uses space filters acquired by separating one space filter into two portions including a first space filter and a second space filter, applies the first space filter to the imported pixel data to generate target data positioned in one of the two consecutive lines and applies the second space filter to the imported pixel data to generate target data positioned in the other one of the two lines.

In this configuration, the selector executes selection of the pixel data to be used in the processing at the low resolution, in other words, a reduction of the data amount by discarding or skipping of pixel data which are not necessary for processing at the low resolution. Therefore, the image processor is able to execute processing at the low resolution by importing the minimum necessary image data selected by the selector.

Consequently, when processing at the low resolution, the image processor does not have to import all the pixel data at a speed exceeding the speed required when processing at the normal resolution. Hence, processing at the low resolution is achieved satisfactorily without increasing the speed of importing the pixel data, that is, within a range of performance of the image processor for processing at the normal resolution.

The controller may control the line sensor at a high pixel rate which is higher than the normal pixel rate so that the selected pixel data to be processed at the low resolution is acquired at the same pixel rate as that of all the pixel data to be processed at the low resolution. In this case, the image processor is able to execute processing at the low resolution at a high speed while obtaining the maximum benefit from the performance provided for processing at the normal resolution. In other words, the low-resolution high-speed mode is achieved.

The controller may control the line sensor at the normal pixel rate when processing at the low resolution, so that the selected pixel data to be processed at the low resolution is acquired at a pixel rate lower than that of all the pixel data to be processed at the normal resolution. In this case, the image processor is able to execute processing at the low resolution at a power consumption lower than that when processing at the normal resolution by lowering the drive clock in association with the lowering of the pixel rate. In other words, the low-resolution low-power mode is achieved.

Since the target data is acquired by applying the space filter to the selected pixel data, the correction of the position of the center of gravity of the pixel and the smoothing of the pixel data are achieved at the same time.

In other words, a cyclical noise caused by the arrangement of the selected pixels (for example, a moiré pattern caused by pixels aligned in the oblique direction when selecting the odd-numbered pixels and the even-numbered pixels alternately from line to line) is reduced. Even when the characteristic difference is included individually in the pixel data of the odd-numbered pixels and the even-numbered pixels, since the space filter is applied to the pixel data over a plurality of lines, the characteristic difference is mixed uniformly to a certain degree, so that the visual non-uniformity is reduced.

Furthermore, since spatial distribution of the pixels to be used may be set more uniformly in comparison with the related art in which only one of the odd-numbered pixels and the even-numbered pixels are used, improvement of the image quality of the acquired image is expected.

The image processing apparatus according to a preferred embodiment of the present invention is preferably an image processing apparatus for processing pixel data acquired by scanning a document with a line sensor at a normal resolution and at a low resolution which is lower than the normal resolution, and preferably includes a selector arranged to select the pixel data of pixels at different positions in the line on the line-to-line basis from all the pixel data when all the pixel data is acquired at a first pixel rate by scanning a plurality of consecutive lines and output the selected pixel data at a second pixel rate which is lower than the first pixel rate when processing at the low resolution; and an image processor including a buffer unit arranged to accumulate the selected pixel data and output the accumulated pixel data at the first pixel rate and the filter unit arranged to generate the target data by applying different space filters to the pixel data outputted from the buffer unit depending on the line where the target data to be acquired is positioned.

In this configuration, since the buffer unit in the image processor accumulates the pixel data to be processed at the low resolution acquired from the selector at the second pixel rate and outputs the same at the first pixel rate which is equal to the pixel rate of all the pixel data to be processed at the normal resolution, the filter unit in the image processor is able to execute the processing at the low resolution at a high speed while obtaining the maximum benefit from the performance provided for the processing at the normal resolution. In other words, another configuration which achieves the low-resolution high-speed mode is obtained without switching the pixel rate for controlling the line sensor.

Preferred embodiments of the present invention include not only the image processing apparatus as described above, but also a network multifunction peripheral having the image processing apparatus integrated therein.

According to the image processing apparatus and the network multifunction peripheral in the various preferred embodiments of the present invention, since the selector executes selection of the pixel data required for the processing at the low resolution, the image processor is able to execute the processing at the low resolution by importing the required minimum pixel data selected by the selector.

Consequently, when processing at the low resolution, the image processor does not have to import all the pixel data at a speed exceeding the speed required when processing at the normal resolution and hence processing at the low resolution is achieved satisfactorily without increasing the speed of importing the pixel data, that is, within a range of performance of the image processor for processing at the normal resolution.

At this time, since the above-described low-resolution high-speed mode or the low-resolution low-power mode is achieved depending on whether the controller controls the line sensor at the high pixel rate or at the normal pixel rate, a trade-off between the processing speed and the power consumption when processing of the document image at the low resolution is enabled.

Furthermore, when processing the image data at the low resolution, the quantity of the image data that the image processor should import may be reduced to a level smaller than the case of the processing at the normal resolution, and hence the processing time (the amount of data to be processed) in the image processor is effectively reduced.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates an example of the configuration of a communication system including a network multifunction peripheral according to a preferred embodiment of the present invention.

FIG. 2 illustrates an example of the hardware configuration of the network multifunction peripheral.

FIG. 3 is a block diagram illustrating an example of the functional configuration of characteristic portions of a preferred embodiment of the present invention.

FIG. 4 illustrates timing of principal signals relating to characteristic actions of a preferred embodiment of the present invention.

FIG. 5 illustrates pixels to be processed at a low resolution from among all the pixels.

FIG. 6 illustrates an example of an image data format held in a buffer.

FIGS. 7A and 7B illustrate an example of the filter coefficients for generating target data positioned in the odd-numbered lines.

FIGS. 8A and 8B illustrate an example of the filter coefficients for generating target data positioned in the even-numbered lines.

FIGS. 9A and 9B illustrate another example of the filter coefficient for generating target data positioned in the odd-numbered lines.

FIGS. 10A and 10B illustrate another example of the filter coefficient for generating target data positioned in the even-numbered lines.

FIG. 11 conceptually illustrates a configuration of a general image processing apparatus in the related art.

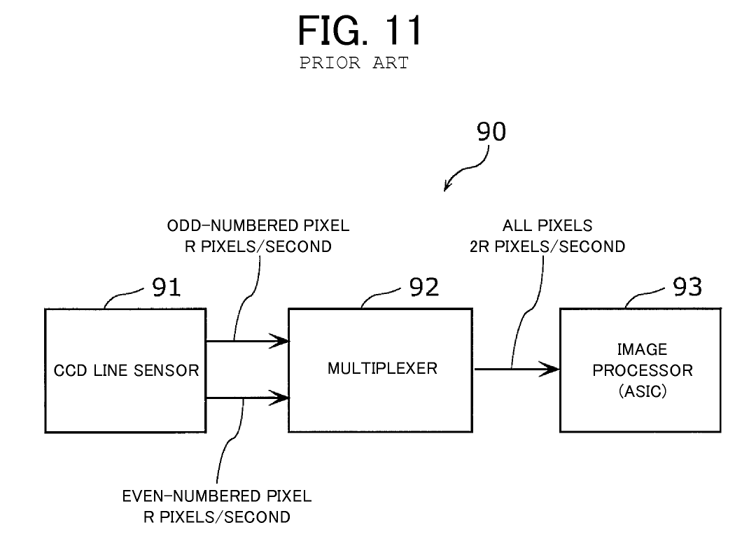

### DETAILED DESCRIPTION OF PREFERRED EMBODIMENTS

Referring now to the drawings, preferred embodiments of the present invention will be described in detail.

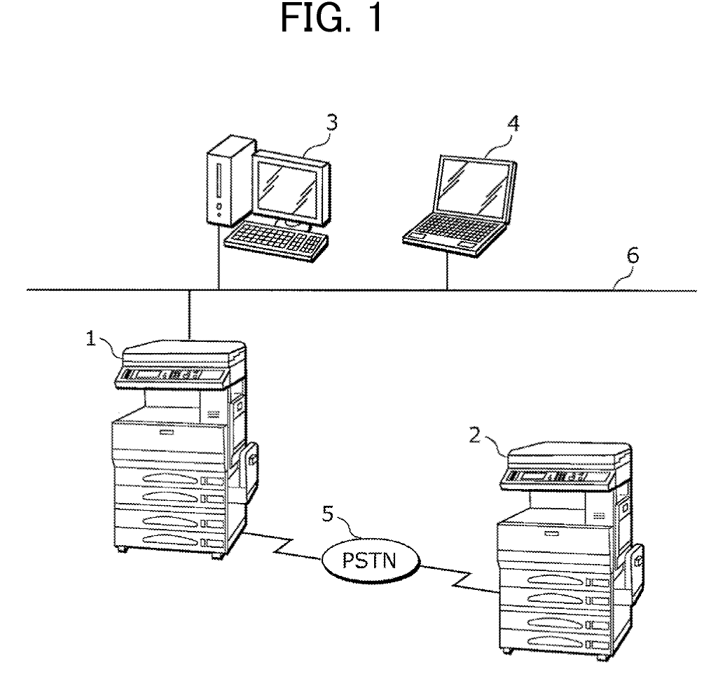

FIG. 1 illustrates an example of the configuration of a communication system including a network multifunction peripheral according to a preferred embodiment of the present invention.

This communication system includes network multifunction peripherals 1 and 2, terminal devices 3 and 4, a Public Switched Telephone Networks (PSTN) 5, and a Local Area Network (LAN) 6.

For example, the network multifunction peripheral 1 corresponds to the network multifunction peripheral according to the preferred embodiments of the present invention, which is connected to the network multifunctional peripheral 2 via the PSTN 5 and is connected to the terminal devices 3 and 4 via the LAN 6.

The network multifunction peripheral 1 transmits a document scanned by a scanner through facsimile transmission to the network multifunction peripheral 2 via the PSTN 5, transmits to the terminal devices 3 and 4 via the LAN 6, and performs printing by a printer integrated therein.

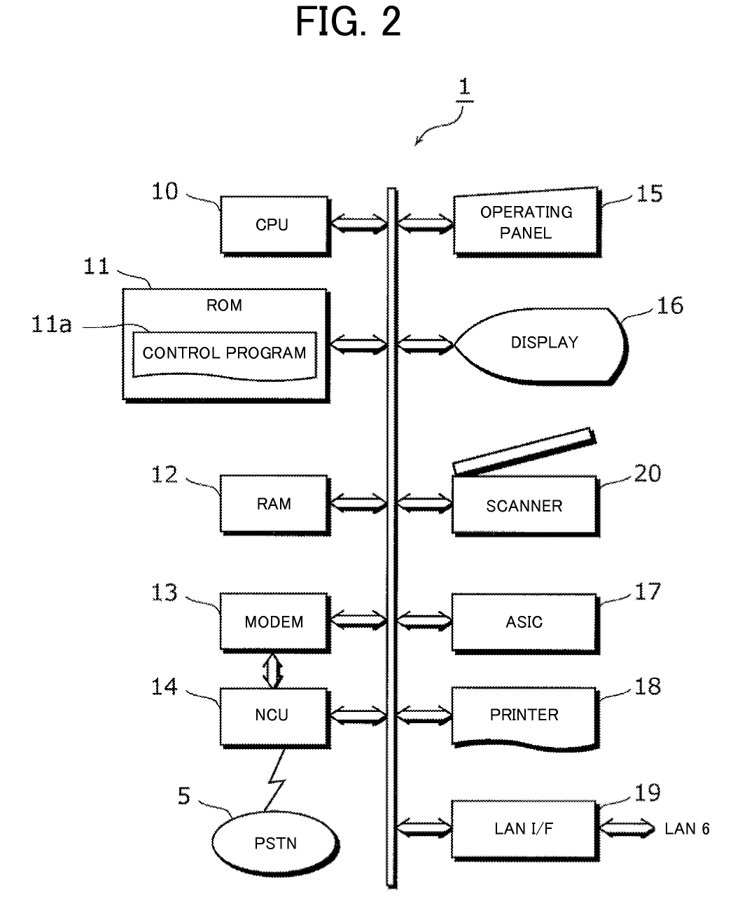

FIG. 2 is a block diagram illustrating an example of the hardware configuration of the network multifunction peripheral 1.

The network multifunction peripheral 1 is an example of an image processing apparatus which processes image data acquired by scanning a document by a line sensor, and includes a Central Processing Unit (CPU) 10, a Read Only Memory (ROM) 11, a Random Access Memory (RAM) 12, a modem 13, a Network Control Unit (NCU) 14, an operating panel 15, a display 16, an ASIC 17, a printer 18, a LAN interface (LAN I/F) 19, and a scanner 20.

The CPU 10 controls the entire network multifunction peripheral 1 by executing a control program 11a stored in the ROM 11.

The CPU 10 receives a signal indicating a resolution specifying operation executed by a user from the operating panel 15 and supplies a control signal indicating a normal resolution or a low resolution to the scanner 20 according to the specification by the user. Then, the CPU 10 applies image processing on pixel data outputted from the scanner 20 at the normal resolution or the low resolution according to the control signal in the ASIC 17 and stores the image data acquired thereby in the RAM 12, and then transfers the stored image data from the RAM 12 to the printer 18, the modem 13, and the LAN I/F 19. Accordingly, copying, facsimile transmission, and transmission respectively of the document to the terminal device 3 are carried out according to the user-specified resolution.

The ROM 11 is a read only memory for storing the control program 11a executed by the CPU 10.

The RAM 12 is a readable and writable memory for storing work data used by the CPU 10 for executing the control program 11a, pixel data acquired from the scanner 20, and image data acquired by the ASIC 17.

The modem 13 modulates the image data held in the RAM 12 into a facsimile signal and transmits the same, and demodulates the facsimile signal received from the outside into image data. The modem 13 is a facsimile modem which complies with, for example, the G3 standard.

The NCU 14 is a network control device for controlling the connection between the modem 13 and the PSTN 5.

The operating panel 15 is a touch panel for accepting the operation by the user including the resolution specifying operation described above.

The display 16 is a display device for displaying an operation guide for users or an operating state of the network multifunction peripheral 1, and is, for example, a Liquid Crystal Display (LCD).

The ASIC 17 is an integrated circuit having a specific circuit for importing the pixel data outputted from the scanner 20 and processing the same, and includes, a space filter circuit which has a smoothing (low-passing) function.

The printer 18 is a printing device and prints the document image expressed by the image data held, for example, in the RAM 12 under the control of the CPU 10.

The LAN I/F 19 is a communication adapter which connects the network multifunction peripheral 1 and the LAN 6, and transmits the image data retained, for example, in the RAM 12 to the terminal device 3, etc. under the control of the CPU 10.

The scanner 20 is an image scanning device, and outputs all or a portion of the pixel data acquired by optically scanning the document using the CCD line sensor under the control of the CPU 10. All the pixel data acquired from the CCD line sensor is outputted when the control signal indicating the normal resolution is provided by the CPU 10, and a portion of the pixel data is outputted when the control signal indicating the low resolution is provided.

In this case, as is publicly known, the CCD line sensor is an image pickup device including a plurality of pixel circuits arranged in line and a CCD for transferring the signals obtained in the individual pixel circuits as a result of photoelectric conversion.

Among others, the network multifunction peripheral 1 is characterized by the operation performed by the scanner 20 and the ASIC 17 when processing the document image at the low resolution.

In other words, when processing the document image at the low resolution, the scanner 20 selects pixel data from pixels at different positions in a line on a line-to-line basis from the pixel data acquired by scanning a plurality of consecutive lines, and outputs only the selected pixel data.

The scanner 20 may select only one pixel data of the pixels located at the same positions in each line from among the pixel data acquired by scanning consecutive N-lines (N is an integer larger than one). In other words, the scanner 20 may divide the pixels in the lines into N-groups and select the pixel data of the pixels each of which belongs to different groups in each of the consecutive N-lines.

For example, when the value N is “2”, the pixels in the line are divided into odd-numbered pixels and even-numbered pixels, and the pixel data of the odd-numbered pixels are selected in one of consecutive two lines and the pixel data of the even-numbered pixels are selected in the other of the consecutive two lines.

The ASIC 17 imports the pixel data selected by the scanner 20, and generates the target data by applying the space filters (hereinafter, referred simply to “filter”), which are different depending on the line where the target data to be acquired is positioned, to the imported pixel data.

This filter has at least a function to generate the target data by smoothing (low-passing) the pixel data, and may further include an outline correcting function or the like. The ASIC 17 may correct inclination or distortion of the image using affine transformation or the like, and is able to execute various image processing such as 90° rotation, compression, and expansion.

Subsequently, a characteristic portion according to a preferred embodiment of the present invention in the network multifunction peripheral 1 will be described in detail.

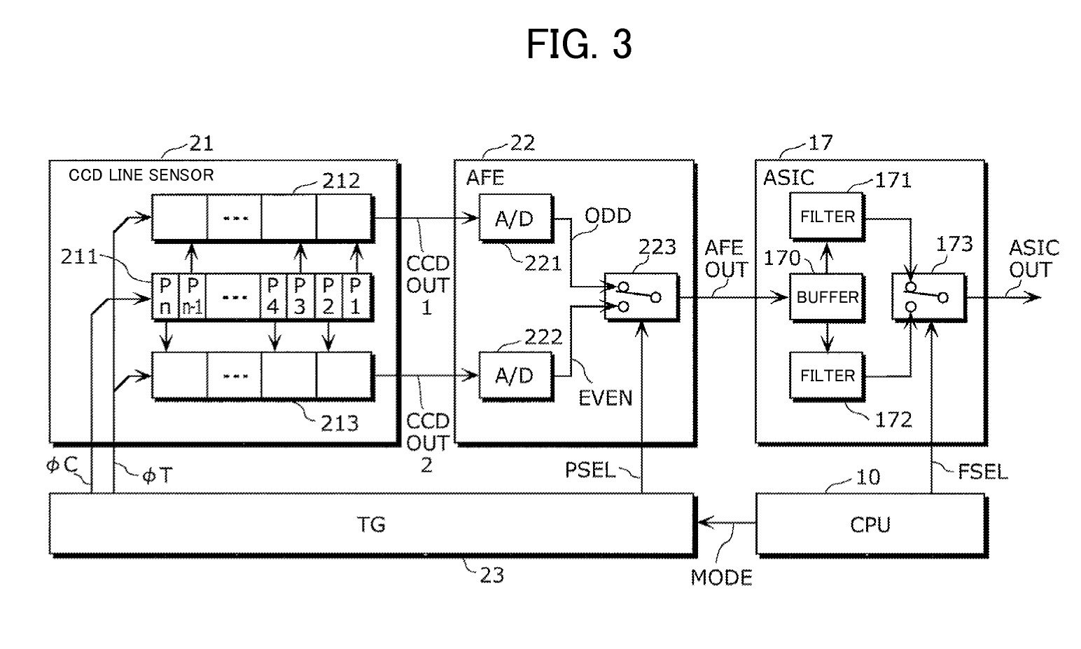

FIG. 3 is a block diagram illustrating an example of the functional configuration of a characteristic portion of a preferred embodiment of the present invention.

The characteristic portion includes the CPU 10, the ASIC 17, and internal components of the scanner 20 including a CCD line sensor 21, an analog front end (AFE) 22, and a timing generator (TG) 23.

In this configuration, examples of a controller are the CPU 10 and the TG 23, an example of a selector is the AFE 22, and an example of an image processor is the ASIC 17.

The scanner 20 includes a known mechanism for scanning the document in a flat bed scan (FBS) system and an automatic document feed (ADF) system. Since the mechanical configuration of the scanner 20 is not a characteristic of the present invention, the description thereof is omitted.

The CCD line sensor 21 includes a pixel unit 211 having a plurality of pixel circuits arranged in a line, a CCD 212 connected to outputs of the odd-numbered pixel circuits for transferring a signal electric charge acquired at each odd-numbered pixel circuit, and a CCD 213 connected to outputs of the even-numbered pixel circuits for transferring a signal electric charge acquired at each even-numbered pixel circuit.

The pixel unit 211 accumulates signal electric charges by executing the photoelectric conversion synchronously with a control signal φC provided by the TG 23 and outputs the accumulated signal electric charges to the CCD 212 and the CCD 213.

The CCD 212 and the CCD 213 transfer the signal electric charges synchronously with a drive clock φT provided by the TG 23 in parallel and output a pixel signal CCDOUT1 and a pixel signal CCDOUT2 according to the signal electric charges transferred to the terminal ends in sequence from the output terminals of the CCD 212 and the CCD 213, respectively.

The AFE 22 includes an analog/digital converter (A/D) 221 for converting the pixel signal CCDOUT1 to odd-numbered pixel data ODD relating to the odd-numbered pixels, an A/D converter 222 for converting the pixel signal CCDOUT2 to even-numbered pixel data EVEN relating to the even-numbered pixels, and a switch 223 for selecting one of the odd-numbered pixel data ODD and the even-numbered pixel data EVEN according to a control signal PSEL and outputting the same as an AFEOUT.

Although the AFE 22 generally includes a functional portion for sample-holding the pixel signal CCDOUT1 and the pixel signal CCDOUT2 in addition to the present configuration for applying offset and gain adjustment, the description thereof will be omitted here.

The TG 23 receives a control signal MODE indicating the normal resolution, a low-resolution low-power mode, or a low-resolution high-speed mode from the CPU 10, and generates the control signal φC and the drive clock φT at a predetermined timing according to the control signal MODE.

The TG 23 generates the drive clock φT having a basic frequency for controlling the CCD line sensor 21 at a normal pixel rate when the control signal MODE indicates the normal resolution or the low-resolution low-power mode, and generates the drive clock φT having a frequency two times the basic frequency for controlling the CCD line sensor 21 at a high pixel rate when the control signal MODE indicates the low-resolution high-speed mode.

The TG 23 generates the control signal PSEL for selecting the odd-numbered pixel data and the even-numbered pixel data in sequence in a cycle of the drive clock φT when the control signal MODE indicates the normal resolution. The TG 23 also generates a control signal PSEL for selecting only the odd-numbered pixel data in one of the two consecutive lines and selecting only the even-numbered pixel data in the other line of the two consecutive lines when the control signal MODE indicates the low-resolution low-power mode or the low-resolution high-speed mode.

The TG 23 outputs the control signal φC and the drive clock φT to the CCD line sensor 21 and the control signal PSEL to the AFE 22.

It is to be noted that a color scanner which is able to detect a plurality of color components is provided with the same configuration of the CCD line sensor 21 and the AFE 22 illustrated in FIG. 3 by the number of the detected color components (four sets for red, green, blue, and monochrome which detects only the brightness of the document). These configurations may be controlled in common by the control signal illustrated in FIG. 3.

The ASIC 17 includes a buffer 170 for storing a predetermined number of lines of the pixel data acquired from the AFE 22, filters 171, 172 for generating target data by processing the pixel data held in the buffer 170 using different filter coefficients, and a switch 173 for selecting one of the outputs from the filters 171, 172 according to a control signal FSEL and outputting the same as an ASICOUT.

The filter 171 is used for generating the target data positioned in the odd-numbered lines when processing at the low resolution, and the filter 172 is used for generating the target data positioned in the even-numbered lines when processing at the low resolution.

The CPU 10 outputs the control signal FSEL indicating one of the odd-numbered lines and the even-numbered lines where the target data to be generated is positioned to the ASIC 17. The switch 173 outputs the output from one of the filter 171 and the filter 172 according to the control signal FSEL as the ASICOUT.

Operation timing of the CCD line sensor 21 and the AFE 22 under the control of the TG 23 will be described in detail.

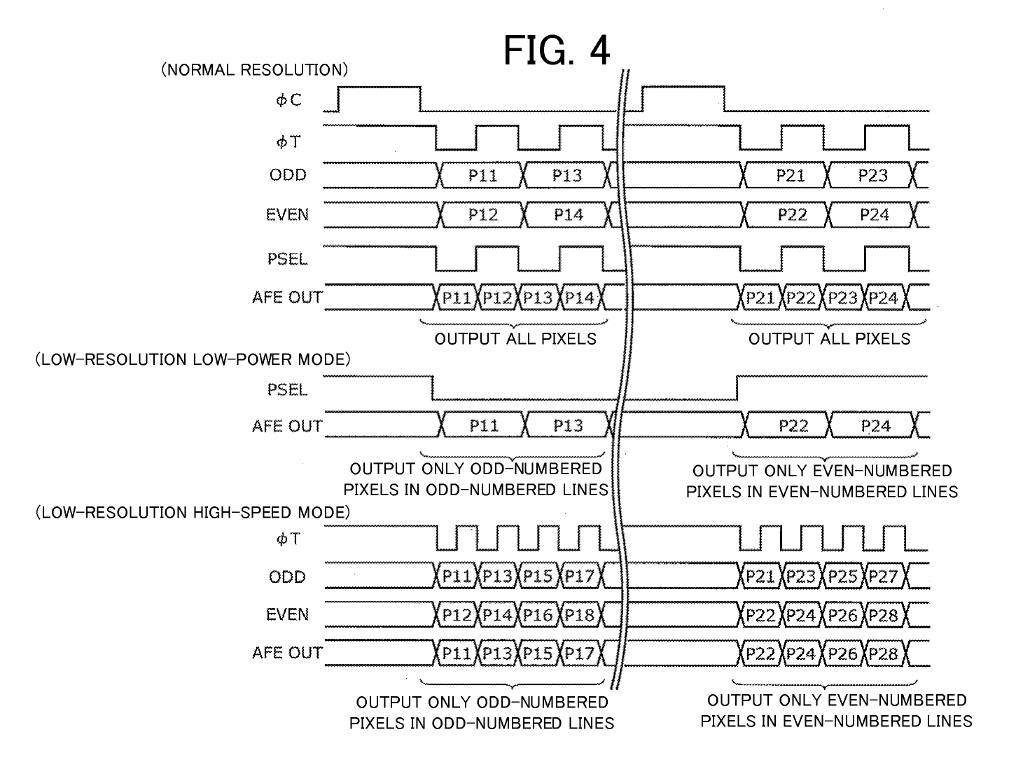

FIG. 4 illustrates timings of principal signals relating to the operations of the CCD line sensor 21 and the AFE 22, respectively, for the normal resolution, the low-resolution high-speed mode, and the low-resolution low-power mode.

The upper level in FIG. 4 illustrates the timings of the principal signals in a case in which the document image is processed at the normal resolution, that is, when the control signal MODE indicating the normal resolution is provided by the CPU 10. The middle level and the lower level in FIG. 4 illustrate signals to be changed when processing the document image in the low-resolution low-power mode and the low-resolution high-speed mode, that is, when the control signal MODE which indicates the low-resolution low-power mode and the low-resolution high-speed mode is provided by the CPU 10.

The TG 23 accumulates the signal electric charges in the pixel unit 211 by outputting the control signals φC to any of the resolutions and modes in common and causes the accumulated signal electric charges to be outputted to the CCD 212 and the CCD 213.

Subsequently, the TG 23 outputs the drive clock φT. The drive clock φT having the basic frequency is outputted at the normal resolution and the low-resolution low-power mode. The CCD line sensor 21 outputs the pixel signal CCDOUT1 and the pixel signal CCDOUT2 synchronously with the drive clock φT respectively from the individual output terminals at the normal pixel rate in parallel. In the low-resolution high-speed mode, the drive clock φT having a frequency two times the basic frequency is outputted. Then, the CCD line sensor 21 outputs the pixel signals CCDOUT1 and the pixel signal CCDOUT2 synchronously with the drive clock φT respectively from the individual output terminals in parallel at a high pixel rate.

The two pixel signals CCDOUT1 and CCDOUT2 outputted in parallel are digitized into the odd-numbered pixel data ODD and the even-numbered pixel data EVEN by the A/D converter 221 and the A/D converter 222, respectively.

When processing in the normal resolution, the TG 23 outputs the control signal PSEL which is varied between the low level and the high level (that is, the same as the drive clock φT) within a cycle of the drive clock φT.

The switch 223 multiplies the odd-numbered pixel data ODD and the even-numbered pixel data EVEN within a cycle of the drive clock φT according to the control signal PSEL and outputs the same as the AFEOUT. The AFEOUT includes the pixel data relating to all the pixels outputted from the CCD line sensor 21.

At this time, assuming that the output rates of the odd-numbered pixel data ODD and the even-numbered pixel data EVEN are R pixels/second, respectively, the output rate of the AFEOUT is 2R pixels/second.

On the other hand, when processing in the low-resolution low-power mode and the low-resolution high-speed mode, the TG 23 outputs the control signal PSEL which retains in a low level one of the two consecutive lines (for example, odd-numbered lines) and obtains a high level in the other one (for example, even-numbered lines).

The switch 223 selects the odd-numbered pixel data ODD in the odd-numbered lines and selects the even-numbered pixel data EVEN in the even-numbered lines according to the control signal PSEL. Accordingly, when processing at the low resolution, the AFEOUT which indicates only the odd-numbered pixel data ODD is outputted in the odd-numbered lines, and the AFEOUT which indicates only the even-numbered pixel data EVEN is outputted in the even-numbered lines. In other words, the pixel data at the low resolution corresponding to a half of the total number of pixels is outputted as the AFEOUT.

Assuming that the output rates of the odd-numbered pixel data ODD and the even-numbered pixel data EVEN are R pixels/second respectively, the output rate of the AFEOUT is R pixels/second in the low-resolution low-power mode and is 2R pixels/second in the low-resolution high-speed mode.

The ASIC 17 imports the pixel data indicated by the AFEOUT, and applies a filter to the imported pixel data. The detailed description of the filter will be addressed below.

According to the configuration of the present preferred embodiment, the output rate of the AFEOUT in the low-resolution high-speed mode is equal to 2R pixels/second which is the output rate of the AFEOUT when processing at the normal resolution. It is apparent that processing at a low resolution is executed at a high-speed while obtaining the maximum benefit from the performance provided for the ASIC 17 for processing at the normal resolution without increasing the speed of importing the image data of the ASIC 17.

In the low-resolution low-power mode, the power consumed by the ASIC 17 is reduced, for example, by reducing the drive clock of the ASIC 17 to a half in association with the reduction of the output rate of the AFEOUT to a half the output rate of the AFEOUT when processing at the normal resolution.

The selection of the mode between the low-resolution low-power mode or the low-resolution high-speed mode may be determined according to, for example, the specifying operation by the user. More specifically, the operating panel 15 outputs a signal indicating that the operating panel 15 has detected a predetermined specifying operation to the CPU 10, the CPU 10 selects one of the low-resolution low-power mode and the low-resolution high-speed mode according to the signal, and outputs the control signal MODE which indicates the result of the selection, so that the selection according to the specifying operation by the user is achieved.

As an application, the CPU 10 may be adapted to select the low-resolution low-power mode in a default setting, and select the low-resolution high-speed mode when the specifying operation by the user requests high-speed processing for the case having a large number of documents.

In addition to depending on the specifying operation by the user, the CPU 10 may select the low-resolution low-power mode when scanning the document using the FBS system, and the low-resolution high-speed mode when scanning the document using the ADF system.

Furthermore, in the case of scanning the document in the ADF system as well, the CPU 10 may detect the quantity of the documents placed on an automatic document feeder of the scanner 20 by the thickness or the weight, etc., and select the low-resolution low-power mode when a small quantity is detected and select the low-resolution high-speed mode when a large quantity is detected.

Subsequently, the filtering process to be executed for the pixel data which is imported by the ASIC 17 when processing at the low-resolution will be described in detail.

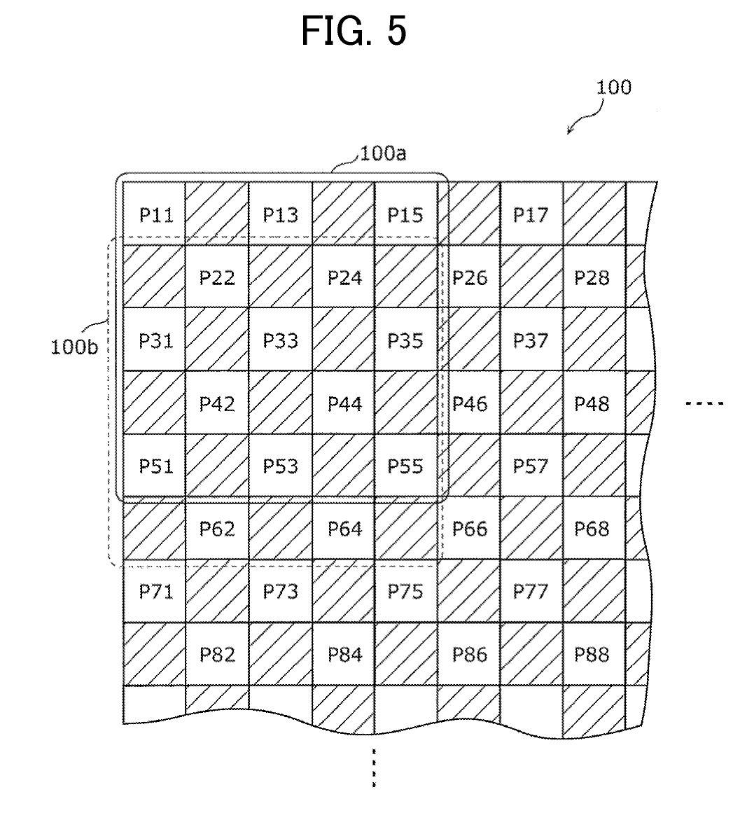

FIG. 5 illustrates pixels to be processed at the low resolution from among all the pixels 100 outputted from the CCD line sensor 21. In FIG. 5, each lateral row corresponds to one line of the CCD line sensor 21. In FIG. 5, for understanding the pixel positions, the pixels selected as the object to be processed in each line are designated by reference signs and the pixels which are not selected are hatched.

FIG. 5 illustrates an example in which odd-numbered pixels P11, P13 P15, P17, . . . are selected as objects to be processed in a first line, and even-numbered pixels P22, P24, P26, P28, . . . are selected as objects to be processed in a second line.

A pixel range 100a indicates a range of pixels to which the filter 171 is to be applied for generating target data at a third pixel in a third line as an example.

A pixel range 100b indicates a range of pixels to which the filter 172 is to be applied for generating target data at the third pixel in a fourth line as an example.

In this example, the pixel ranges 100a, 100b are both 5-lines by 5-pixels square areas.

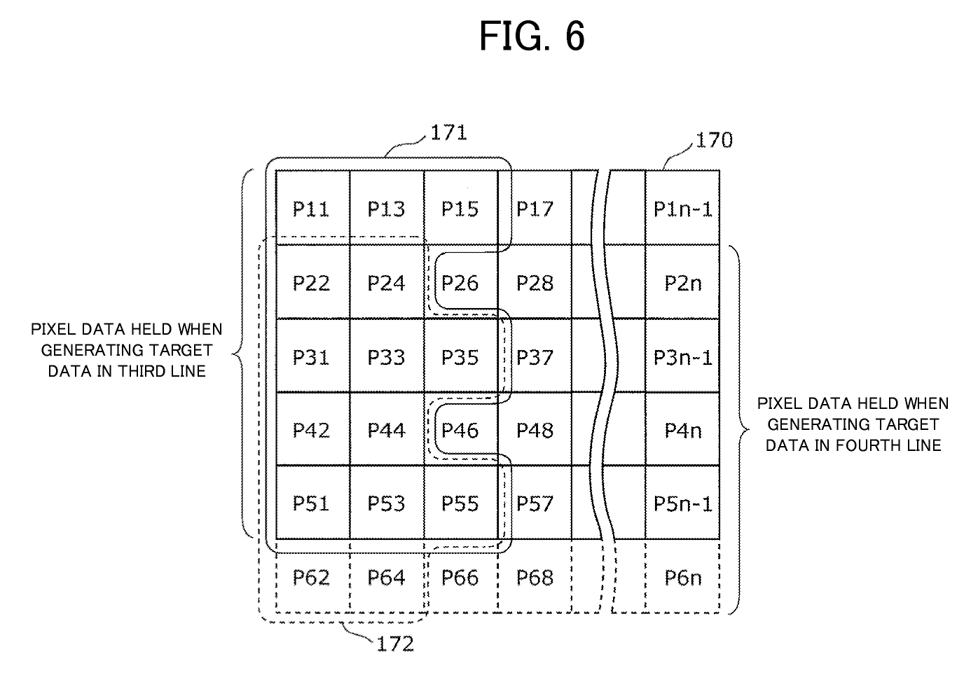

FIG. 6 illustrates an example of a format of the pixel data held in the buffer 170 of the ASIC 17. The buffer 170 holds the pixel data which comes from lines including at least the range where the filter is applied (the first line to the fifth line in this example). The selected pixels are moved over the area of unselected pixels.

For example, when the pixel data which comes from the first line to the fifth line are held in the buffer 170, the filter 171 is applied to the held pixel data several times by shifting the pixel position in sequence, so that the plurality of target data positioned in the third line are generated.

After having finished this generation, the buffer 170 discards the pixel data in the first line, and imports the pixel data in a sixth line. As a consequence, the pixel data from the second line to the sixth line are held in the buffer 170. The filter 172 is applied to the held pixel data several times by shifting the pixel position in sequence, so that the plurality of target data positioned in the fourth line are generated.

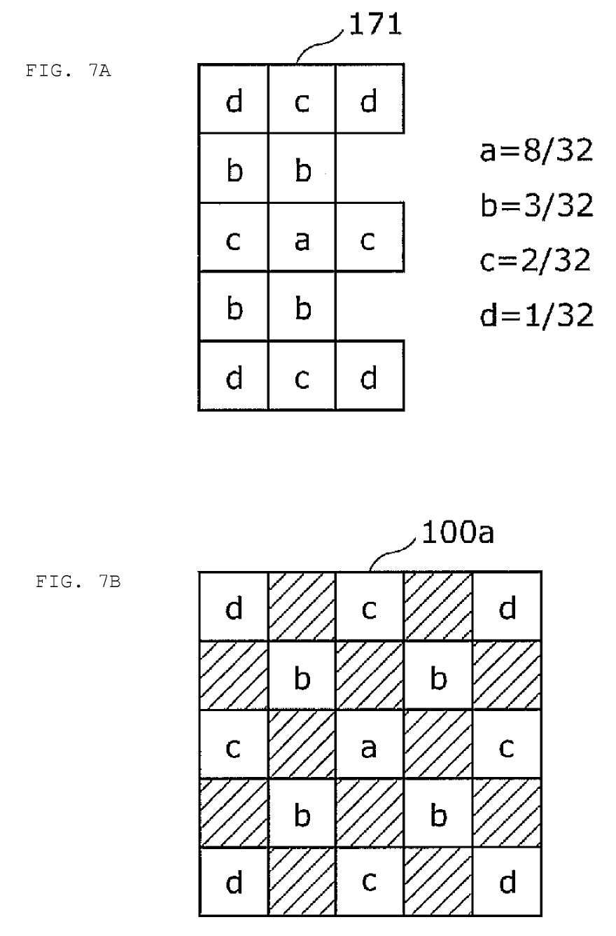

FIG. 7A illustrates a detailed example of the filter coefficients of the filter 171. The filter 171 generates target data by calculating a sum of respective products of the filter coefficients and the pixel values at the same relative positions in the buffer 170. The filter coefficients are examples of the filter coefficients which utilize the smoothing (low-passing) function.

FIG. 7B is a drawing illustrating an arrangement of the filter coefficients of the filter 171 in the pixel range 100a including the unselected pixels.

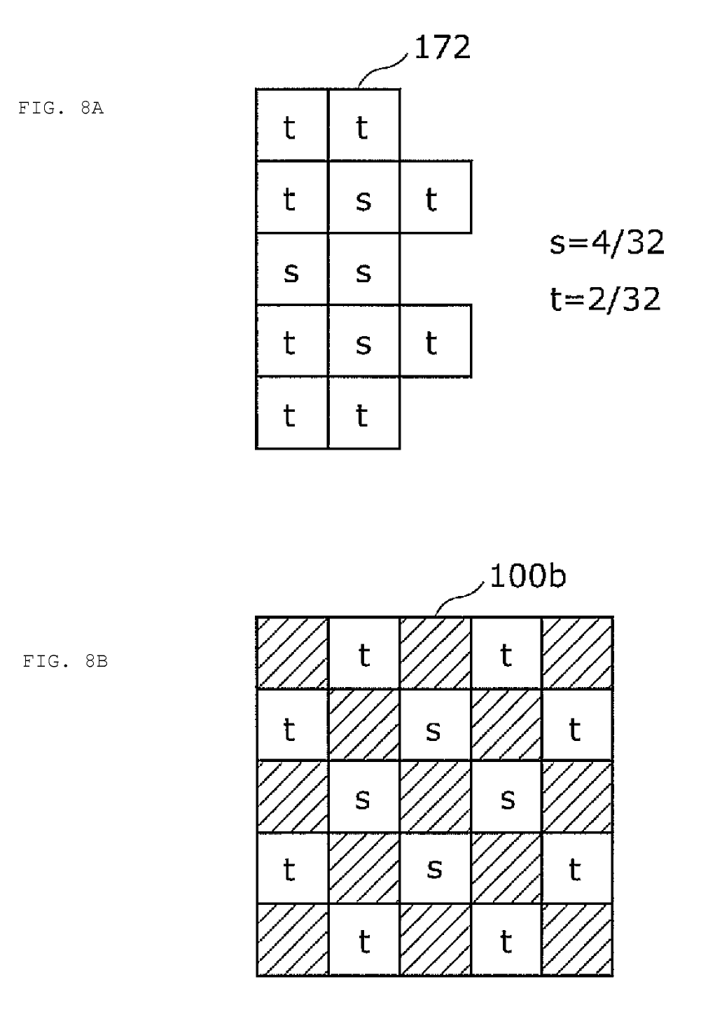

FIG. 8A illustrates a detailed example of the filter coefficients of the filter 172. The filter 172 generates target data by calculating a sum of respective products of the filter coefficients and the pixel values at the same relative positions in the buffer 170. The filter coefficients are examples of the filter coefficients which utilize the smoothing (low-passing) function.

FIG. 8B is a drawing illustrating an arrangement of the filter coefficients of the filter 172 in the pixel range 100b including the unselected pixels.

Referring now to FIG. 7B and FIG. 8B, it is understood that the filter 171 and the filter 172 are obtained by extracting a portion of the coefficients and the remaining coefficients from one filter. In other words, the filter 171 and the filter 172 are obtained by separating one filter into two portions.

It is to be noted that the centers of gravity of the pixels of the filter 171 and the filter 172 agree with each other at the center of the applied ranges. This agreement enables acquisition of the target data at the same positions in the odd-numbered lines and the even-numbered lines even though the distribution of the pixel data used for generating the target data in the odd-numbered lines is different from the distribution of the pixel data used for generating the pixel data in the even-numbered lines.

In this manner, since the target data is acquired by applying the space filter to the selected pixel data, the correction of the position of the center of gravities of the pixels and smoothing of the pixel data are achieved at the same time.

The filter 171 and the filter 172 illustrated in FIG. 7A and FIG. 8A are illustrative only. Other suitable filters may be used in the present invention.

For example, by using a filter which utilizes the smoothing (low-passing) function by applying to a smaller pixel range of 3-lines by 3-pixels, the data quantity that the buffer 170 will hold may be reduced. A detailed example is shown below.

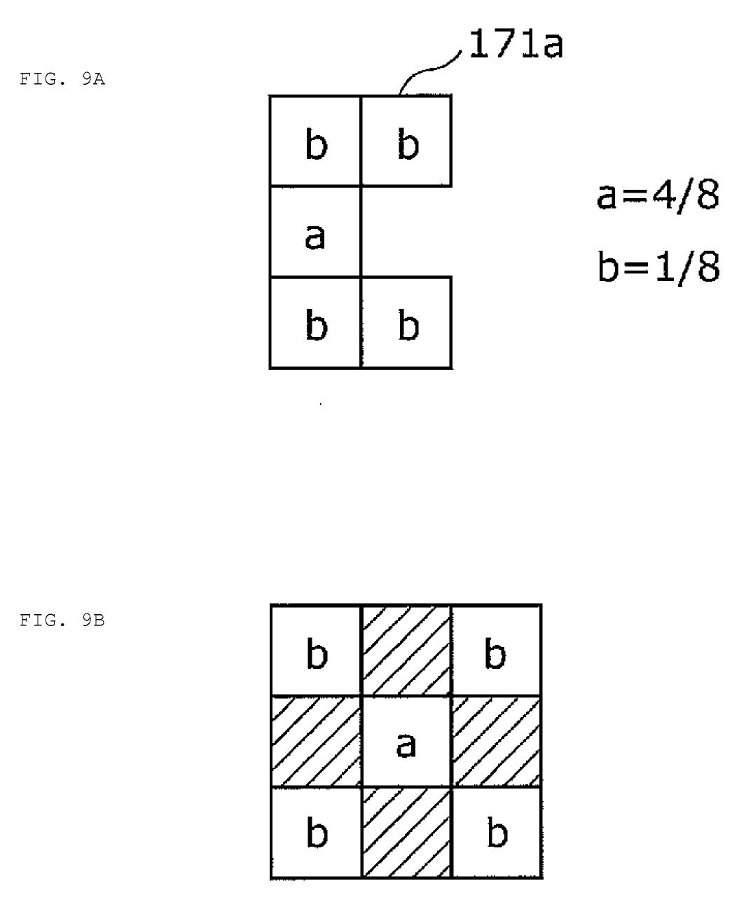

FIG. 9A and FIG. 9B illustrate an example of the filter coefficients of a filter 171a used for generating target data in the odd-numbered lines.

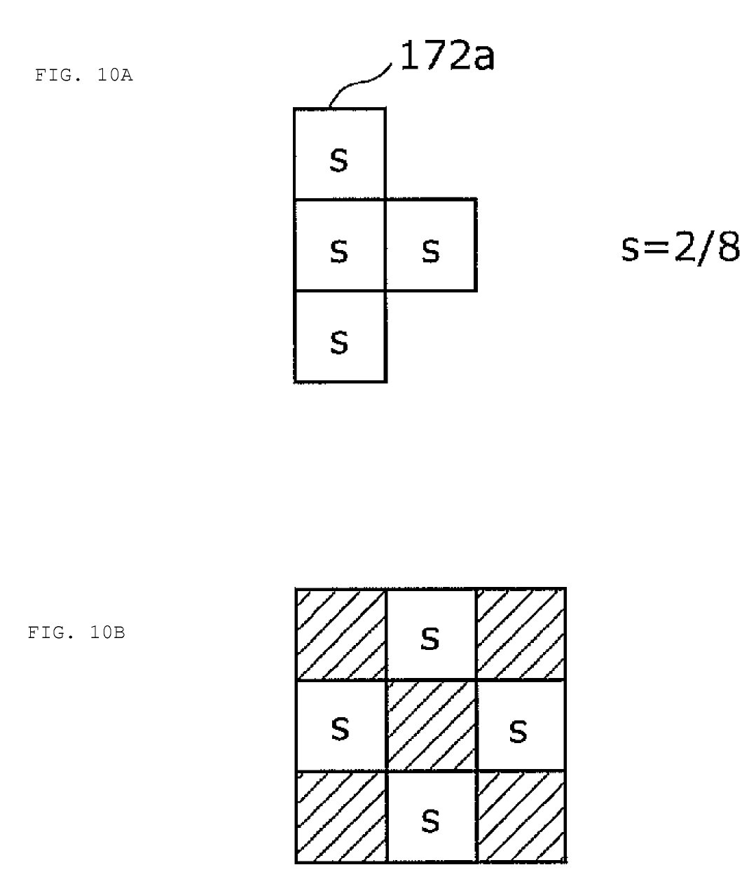

FIG. 10A and FIG. 10B illustrate an example of the filter coefficients of a filter 172a used for generating target data in the even-numbered lines.

The filter 171a and the filter 172a are also obtained by separating a single filter into two portions.

The ASIC 17 has been functionally described with an example of selectively using one of the processing results by the two different filters. The function of the ASIC 17 as described above is also achieved by switching the two different filter coefficients for one single filter circuit in line with actual hardware mounting as a matter of course.

For example, the filter 171 and the filter 172 are achieved by switching the two filter coefficients for one single filter circuit having an application range of 5-lines by 3-pixels. Such two filter coefficients are obtained by expanding the filter coefficients illustrated in FIG. 7A or FIG. 8A so as to add a coefficient value 0 to positions where the coefficient value is missing.

The filter 171a and the filter 172a are achieved by switching two filter coefficients obtained by expanding the filter coefficients illustrated in FIG. 9A and FIG. 10A in the same manner for a single filter circuit having an application range of 3-lines by 2-pixels.

As described thus far, in the network multifunction peripheral 1, since selection of the pixel data required for processing at the low-resolution is achieved by a switch 223 of the AFE 22 according to the control signal PSEL provided from the TG 23, the ASIC 17 is able to execute processing at the low resolution by importing the minimum necessary pixel data selected by the switch 223.

Consequently, when processing at the low resolution, the ASIC 17 does not have to import all the pixel data at a speed exceeding the speed required when processing at the normal resolution. Hence, the processing at the low resolution is achieved satisfactorily without increasing the speed of importing the pixel data, that is, within a range of performance of the ASIC 17 provided for processing at the normal resolution.

More preferably, when processing at the low resolution, the TG 23 may double the frequency of the drive clock φT in comparison with the frequency when processing at the normal resolution. In this arrangement, the output rate of the AFEOUT is unified for processing at the low resolution and for processing at the normal resolution, so that the performance of the ASIC 17 provided for processing at the normal resolution is fully utilized for the processing at the low resolution.

Furthermore, when processing the image data at the low resolution, the quantity of the image data that the ASIC 17 should import may be reduced to a level smaller than the case of the processing at the normal resolution, and hence the processing time (the amount of data to be processed) by the ASIC 17 is effectively reduced.

As a modification, there is another conceivable configuration which achieves the low-resolution high-speed mode which obtains the maximum benefit from the performance of the ASIC 17 for processing at the normal resolution while controlling the CCD line sensor 21 by the drive clock φT having the same basic frequency as the case of the normal resolution and the low-resolution low-power mode described above.

In this configuration, the CCD line sensor 21 outputs all the pixel signals including the odd-numbered pixels and the even-numbered pixels at a pixel rate of 2R pixels/second by being controlled by the drive clock φT at the normal frequency. The AFE 22 selects only the odd-numbered pixel data ODD or only the even-numbered pixel data EVEN on a line-to-line basis, and outputs the selected pixel data at a pixel rate of R pixels/second as AFEOUT.

The buffer 170 in the ASIC 17 accumulates the AFEOUT outputted from the AFE 22 at a pixel rate of R pixels/second and outputs the accumulated pixel data to the filter 171 and the filter 172 at a pixel rate of 2R pixels/second.

The pixel rate of 2R pixels/second is equal to the pixel rate of all pixel data including the odd-numbered pixel data ODD and the even-numbered pixel data EVEN, so that the filter 171 and the filter 172 are able to execute the processing at the lower resolution at a high-speed while obtaining the maximum benefit from the performance provided for the processing at the normal resolution.

In particular, when the output speed (pixel rate) from the buffer 170 is two times the input speed (pixel rate) to the buffer 170, it is desirable to start reading-out of the pixel data of a previous line from the buffer 170 after having accumulated half the pixel data of the previous line in the buffer 170 and before starting the accumulation of the pixel data of a next line.

Accordingly, the pixel data for one line is read out without pause (without the event that the pixel data to be read out is ended halfway), and the required capacity of the buffer 170 needs only to be the capacity corresponding to one line.

Since the filter 171 and the filter 172 process the pixel data generated by the reading-out of the pixel data from the buffer 170 at a speed faster than the writing of the pixel data to the buffer 170, an improved through put is achieved by having the ASIC 17 execute another process during the waiting time, or a power saving is achieved by stopping the drive clock of the ASIC 17.

Even when the drive clock is not stopped, since the operating time of the ASIC 17 is shortened, the power saving is achieved.

The preferred embodiments of the present invention may be applied to network multifunction peripherals, copying machines, facsimile machines, scanners and the like as the image processing apparatus for processing pixel data acquired by scanning documents with a line sensor.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image processing apparatus comprising:
a controller arranged to select one of a plurality of pixel rates from a normal pixel rate and at least one of a plurality of high pixel rates which are higher than the normal pixel rate used when processing at a normal resolution, and control a line sensor so that pixel data is outputted at the selected pixel rate when processing at a low resolution;
a selector arranged to select the pixel data of pixels at different positions in a line on a line-to-line basis from among pixel data acquired by scanning a plurality of consecutive lines; and
an image processor arranged to generate target data by importing the selected pixel data and applying different space filters to the imported pixel data depending on the line where the target data to be acquired is positioned.

2. The image processing apparatus according to claim 1, wherein the controller selects the pixel rate according to a specifying operation executed by a user.

3. The image processing apparatus according to claim 1, wherein the selector selects only one pixel data of pixels at the same position in the line from among pixel data acquired by scanning consecutive N lines, wherein N is an integer larger than one.

4. The image processing apparatus according to claim 1, wherein the space filters are arranged such that one of the space filters is divided into a first space filter and a second space filter, the first space filter is applied to the imported pixel data to generate target data positioned in one of two consecutive lines, and the second space filter is applied to the imported pixel data to generate target data positioned in the other one of the two consecutive lines.

5. An image processing apparatus comprising:
a selector arranged to select pixel data of pixels at different positions in a line on a line-to-line basis from among all the pixel data when all the pixel data is acquired at a first pixel rate by scanning a plurality of consecutive lines and output the selected pixel data at a second pixel rate which is lower than the first pixel rate when processing at a low resolution; and
an image processor including a buffer unit arranged to accumulate the selected pixel data and output the accumulated pixel data at the first pixel rate and a filter unit arranged to generate the target data by applying different space filters to the pixel data outputted from the buffer unit depending on the line where the target data to be acquired is positioned.

6. A network multifunction peripheral comprising:
a printer;
a facsimile communication unit;
a network communication unit;
a controller arranged to select one of a plurality of pixel rates from a normal pixel rate and at least one of a plurality of high pixel rates which are higher than the normal pixel rate used when processing at a normal resolution, and control the line sensor so that the pixel data is outputted at the selected pixel rate when processing at a low resolution;
a selector arranged to select the pixel data of pixels at different positions in a line on a line-to-line basis from among pixel data acquired by scanning a plurality of consecutive lines;
an image processor arranged to generate target data by importing the selected pixel data and applying different space filters to the imported pixel data depending on the line where the target data to be acquired is positioned; and
an output unit arranged to execute at least one of copying, facsimile transmission, and transmission to a terminal device connected via the network communication unit of a document by transferring the generated target data to at least one of the printer, the facsimile communication unit, and the network communication unit.

7. A network multifunction peripheral comprising:
a printer;
a facsimile communication unit;
a network communication unit;
a selector arranged to select pixel data of pixels at different positions in a line on a line-to-line basis from all the pixel data acquired at a first pixel rate by scanning a plurality of consecutive lines and output the selected pixel data at a second pixel rate which is lower than the first pixel rate when processing at a low resolution;
an image processor including a buffer unit arranged to accumulate the selected pixel data and output the accumulated pixel data at the first pixel rate and a filter unit arranged to generate the target data by applying different space filters to the pixel data outputted from the buffer unit depending on the line where the target data to be acquired is positioned; and
an output unit arranged to execute at least one of copying, facsimile transmission, and transmission to a terminal device connected via the network communication unit of a document by transferring the generated target data to at least one of the printer, the facsimile communication unit, and the network communication unit.

8. An image processing method comprising:
selecting one of a plurality of pixel rates including a normal pixel rate and at least one of a plurality of high pixel rates which are higher than the normal pixel rate used in processing at a normal resolution, and controlling a line sensor so that pixel data is outputted at the selected pixel rate when processing at a low resolution;
selecting the pixel data of pixels at different positions in a line on a line-to-line basis from among pixel data acquired by scanning a plurality of consecutive lines; and
generating target data by importing the selected pixel data and applying different space filters to the imported pixel data depending on the line where the target data to be acquired is positioned.
